(19) United States
(12) Patent Application Publication
(10) Pub. No.: US 2024/0054348 A1
(43) Pub. Date: Feb. 15, 2024

(54) SYSTEMS AND METHOD FOR MASKED MULTI-STEP MULTIVARIATE TIME SERIES POWER FORCASTING AND ESTIMATION

(71) Applicant: General Electric Company, Schenectady, NY (US)

(72) Inventors: Yiwei Fu, Schenectady, NY (US); Nurali Virani, Scotia, NY (US); Honggang Wang, Clifton Park, NY (US); Benoit Christophe, Massy (FR)

(21) Appl. No.: 18/327,619

(22) Filed: Jun. 1, 2023

Related U.S. Application Data
(60) Provisional application No. 63/397,966, filed on Aug. 15, 2022.

(51) Int. Cl. G06N 3/0895

(52) U.S. Cl. CPC G06N 3/0895

(57) ABSTRACT

A system includes a computing device including at least one processor in communication with at least one memory. The at least one processor is programmed to (a) store a plurality of historical time series data; (b) randomly select a sequence; (c) randomly select a mask length for a mask for the selected sequence; (d) apply the mask to the selected sequence, wherein the mask is applied to the plurality of forecast variables in the selected sequence; (e) execute a model with the masked selected sequence to generate predictions for the masked forecast variables; (f) compare the predictions for the masked forecast variables to the actual forecast variables in the selected sequence; (g) determine if convergence occurs based upon the comparison; and (h) if convergence has not occurred, update one or more parameters of the model and return to step b.

### CROSS-REFERENCE TO RELATED APPLICATIONS

This patent application claims priority to U.S. Provisional Patent Application Ser. No. 63/397,966, filed Aug. 15, 2022, the entire contents and disclosure of which are hereby incorporated herein by reference in its entirety.

### BACKGROUND

The field of the invention relates generally to predicting further performance of systems, such as, but not limited to, electric power generation and delivery systems and, more particularly, to systems and methods for training machine learning to predict future outputs using multi-step multivariate time series power forecasting.

Accurate short to mid-term forecasting is critical for grid planning and operation. In many cases, time series forecasting that requires multi-step predictions has become an important part of many real-world applications in areas such as electricity demand modeling, air traffic volume prediction, stock prices forecasting, and crop yields estimation. Specifically, there is often some future information available, such as the weather information for short-to-mid-term electricity demand modeling, and jet fuel price for air traffic volume prediction, which is not fully leveraged in the existing forecasting frameworks.

In general, the multi-step time series forecasting problem can be categorized into two kinds of approaches: recursive methods and direct methods. Recursive methods typically use an autoregressive approach (one-step-ahead prediction) and produce multi-step forecasts by recursively feeding samples into the future time steps. However, as an error is often at each step, the recursive structure tends to accumulate large errors over long forecasting horizons. Direct methods, on the other hand, directly map all available inputs to multi-step forecasts and typically use a sequence-to-sequence (seq2seq) structure. The disadvantage of this method is that it is harder to train, especially when the forecast horizon is large.

Accordingly, there is a need for an improved system for multi-step multivariate time series forecasting, for electricity demand modeling, air traffic volume prediction, stock prices forecasting, and crop yields estimation, for example.

### BRIEF DESCRIPTION

In one aspect, a system is provided. The system includes a computing device including at least one processor in communication with at least one memory device. The at least one processor is programmed to store a plurality of historical time series data including a plurality of predictor variables and a plurality of forecast variables. The at least one processor is also programmed to randomly select a sequence including a subset of continuous data points in the plurality of historical time series data. The at least one processor is further programmed to randomly select a mask length for a mask for the selected sequence. In addition, the at least one processor is programmed to apply the mask to the selected sequence, wherein the mask is applied to the plurality of forecast variables in the selected sequence. Moreover, the at least one processor is programmed to execute a model with the masked selected sequence to generate predictions for the masked forecast variables. Furthermore, the at least one processor is programmed to compare the predictions for the masked forecast variables to the actual forecast variables in the selected sequence. In addition, the at least one processor is also programmed to determine if convergence occurs based upon the comparison. If convergence has not occurred, the at least one processor is programmed to update one or more parameters of the model and return to step b. The system may have additional, less, or alternate functionality, including that discussed elsewhere herein.

In another aspect, a computer-implemented method is provided. The method is implemented by a computing device including at least one processor in communication with at least one memory device. The method includes storing a plurality of historical time series data including a plurality of predictor variables and a plurality of forecast variables. The method also includes randomly selecting a sequence including a subset of continuous data points in the plurality of historical time series data. The method further includes randomly selecting a mask length for a mask for the selected sequence. In addition, the method includes applying the mask to the selected sequence, wherein the mask is applied to the plurality of forecast variables in the selected sequence. Moreover, the method includes executing a model with the masked selected sequence to generate predictions for the masked forecast variables. Furthermore, the method comparing the predictions for the masked forecast variables to the actual forecast variables in the selected sequence. In addition, the method also includes determining if convergence occurs based upon the comparison. If convergence has not occurred, the method include updating one or more parameters of the model and return to step b. The method may have additional, less, or alternate functionality, including that discussed elsewhere herein.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIGS. 1A-1D illustrates a plurality of graphs different types of forecasting system in accordance with at least one embodiment.

FIG. 2 illustrates block diagram of a process for training a model for masked multi-step multivariate forecasting in accordance with at least one embodiment.

FIG. 3 illustrates a computer-implemented process for training a model for masked multi-step multivariate forecasting using the process shown in FIG. 2.

FIG. 4 illustrates block diagram of a process for prediction using a masked multi-step multivariate forecasting model in accordance with at least one embodiment.

FIG. 5 illustrates a computer-implemented process for training a model for masked multi-step multivariate forecasting using the process shown in FIG. 4.

FIG. 6 depicts a simplified block diagram of an exemplary computer system for implementing the processes shown in FIGS. 2-5.

FIG. 7 depicts an exemplary configuration of client computer devices, in accordance with one embodiment of the present disclosure.

FIG. 8 illustrates an example configuration of the server system, in accordance with one embodiment of the present disclosure.

FIG. 9 illustrates a graph of comparing different forecasting techniques in accordance with at least one embodiment.

FIG. 10 illustrates another graph of comparing different forecasting techniques in accordance with at least one embodiment.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components, and circuits have not been described in detail so as not to obscure the embodiments.

One or more specific embodiments are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The field of the invention relates generally to predicting further performance of systems, such as, but not limited to, electric power generation and delivery systems and, more particularly, to systems and methods for training machine learning to predict future outputs using multi-step multivariate time series power forecasting. The systems and methods described herein describe a masked multi-step multivariate forecasting (MMMF) system. The MMMF system is a novel and self-supervised learning framework for time series forecasting with known future information. In many real-world forecasting scenarios, some future information is known, e.g., the weather information when making a short-to-mid-term electricity demand forecast, or the future oil prices when making an airplane departure forecast. Existing machine learning forecasting frameworks can be categorized into (1) sample-based approaches where each forecast is made independently, and (2) time series regression approaches where the future information is not fully incorporated. To overcome the limitations of existing approaches, the MMMF system is configured to train any neural network model capable of generating a sequence of outputs, that combines both the temporal information from the past and the known information about the future to make better predictions. Furthermore, once a neural network model is trained with the MMMF system, its inference speed is similar to that of the same model trained with traditional regression formulations, thus making the MMMF system an improvement over existing regression-trained time series forecasting models if there is some available future information.

The MMMF system incorporates known future information directly during training. The MMMF system uses the future information with recursion when making iterative forecasts. The MMMF system integrates a general self-supervised learning task for training time series models (including Recurrent Neural Networks (RNNs), Convolutional Neural Networks (CNNs), and attention-based methods) to make multi-step forecasts with known future information. The MMMF system provides a flexible learning framework that improves upon existing methods by taking into account both recent history and known future information.

In the exemplary embodiment, the MMMF system is used for training neural network (NN)-based multi-step time series forecasting models with known future information. The MMMF system uses a masking technique that is flexible and can generate forecasts of different lengths. The MMMF system improves over existing methods by combining both recent history and known future information.

The Masked Multi-Step Multivariate Forecasting (MMMF) system is configured for training and inference of machine learning models for multi-step multivariate time series forecasting with future information. The MMMF system provides a framework to accommodate any underlying time series models, including recurrent neural networks, transformers, temporal convolutional networks, etc. The MMMF system provides a masked training scheme to combine past information on predictor variables and forecast variables, and future information on predictor variables, to generate all predictions on future forecast variables at once. Furthermore, the MMMF system incorporates historical information and also incorporates future information about the predictor variables. The MMMF system provides a flexible framework that once trained, generates forecasts for both short-term (1-step) predictions and multi-step predictions.

The training method for Masked Multi-Step Multivariate time series Forecasting includes, but is not limited to: Model Initialization; Data Preprocessing; Data Masking; and Model Updating. The MMMF system performs model initialization, which includes specifying a time series model ƒ_{θ} with trainable parameters θ, maximum forecasting horizon k, maximum history length T, and loss function [symbol] . Then the MMMF system performs data preprocessing, which includes partitioning the dataset S={zᵢ}={(xᵢ, yᵢ)} into length (T+k+1) sequences {z_{t-T}, . . . , zₜ₋₁, zₜ, zₜ₊₁, . . . , zₜ₊ₖ}, where t is the current step, xᵢ are the predictor variables, yᵢ are the forecast variables.

The MMMF system next performs data masking by randomly choosing B sequences, for each sequence, randomly choose a mask length of 0<lₘ≤k+1, and masking the last lₘ steps of forecast variables y. Additionally, the MMMF system performs model updating including providing masked sequences to model ƒ_{θ} and generate forecasts ŷ for the masked outputs. The MMMF system sggregates the total loss [symbol] (y, ŷ) for B sequences, update model parameters θ. The MMMF system repeats the Data Masking and Model Updating for n epochs or until convergence.

In at least one embodiment, the loss function could be means square error (MSE), means absolute percentage error (MAPE), means absolute percentage deviation (MAPD), mean absolute scale error (MASE), symmetric mean absolute percentage error (sMAPE), Mean Directional Accuracy (MDA), and/or any other error or loss function needed.

In at least one embodiment, the model may include, but is not limited to: long short-term memory networks (LSTM), transformer, temporal convolution networks, and/or any other sequence to sequence model.

The Masked Multi-Step Multivariate Forecasting (MMMF) system described herein is a new self-supervised learning framework for multi-step time series forecasting with known future information. One of the advantages of this MMMF system is that it provides more than just a new model and a set of hyperparameters for a particular problem. The MMMF system provides a general training task can outperform existing time series forecasting approaches, including recursive methods and direct methods while using the same base model. Once trained with MMMF, a time series model can generate any length forecasts below the maximum forecast length during training, and the inference speed, as well as the memory usage, are similar to those of traditional methods. Accordingly, the MMMF system is an upgrade to existing deep learning-based multi-step time series forecasting models for real-world forecasting applications where some future information is available.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, servers, and respective processing elements thereof.

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

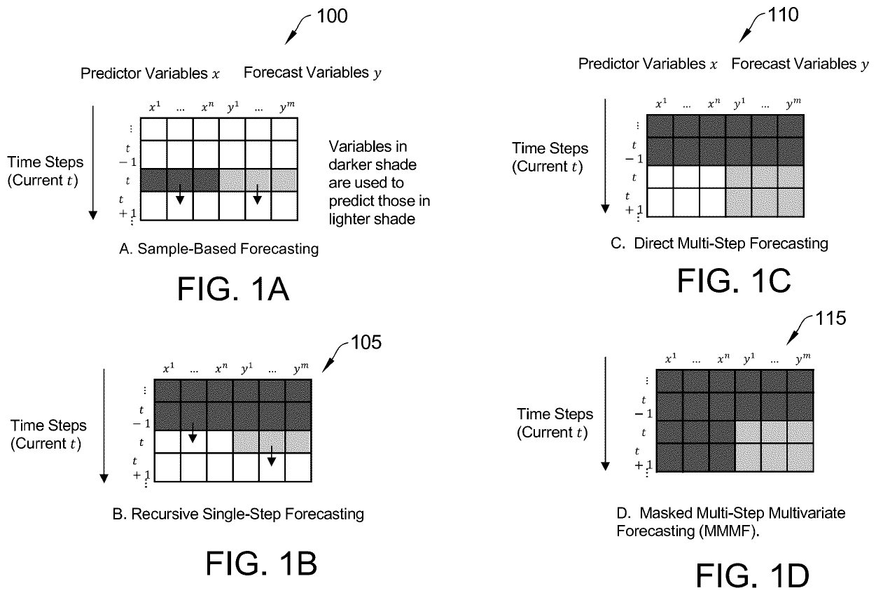

FIGS. 1A-1D illustrates a plurality of graphs different types of forecasting system in accordance with at least one embodiment. For each of these graphs, the variables in the darker shade are used to predict those in the lighter shade. The darker variables are the predictor variables x. The lighter variables are the forecast variables y. The graphs illustrate time t as going in a downward direction, where t is the current time.

Graph 100 illustrates sample-based forecasting (SBF). This is a non-time series SBF regression method, which treats each future prediction separately. SBF makes forecasts with only predictor variables at each step and then moves to the next step.

Graph 105 illustrates recursive single-step forecasting (RSF). RSF makes a single-step prediction on current forecast variables using past information, then advances the time window and makes predictions recursively.

Graph 110 illustrates direct multi-step forecasting (DMF). DMF directly maps past information to multi-step future predictor variables.

As shown in graphs 105 and 110, RSF and DMF do not utilize the knowledge of some future information for making forecasts.

Graph 115 illustrates Masked Multi-Step Multivariate Forecasting (MMMF). MMMF directly uses all available past and future information to predict all forecast variables. In MMMF, predictor variables x from both past and future are known, while forecast variables y are only known in the past. The time series data of known past predictor variables x and the known past forecast variables y are used to train the MMMF model. The time series data used in MMMF is often continuous. In training, MMMF replaces all masked variables with random values within the ranges of those variables. As explained further herein MMMF calculates the loss on only the masked outputs. In inference or prediction, MMMF uses the known future predictor variables x to determine the forecast variables y.

Graphs 100, 105, 110, and 115 illustrate various solutions for a multivariate time series forecasting problem. In the multivariate time series forecasting problem, let xₜ∈ [symbol] ⁿ be a sample of predictor variables x with dimension n at time t and the j-th dimension is denoted as xₜ^{j} (i.e., xₜ=[xₜ¹, xₜ², . . . , xₜⁿ]). Let yₜ∈ [symbol] ⁿ be a sample of forecast variables y with dimension m at time t (i.e., yₜ=[yₜ¹, yₜ², . . . , yₜⁿ]). The task of process 200 is to predict up to (k+1) steps (k>0) of forecast variables yₜ, yₜ₊ᵢ, . . . , yₜ₊ₖ from past T-step information and some knowledge about the future predictor variables x up to time t+k.

A distinct feature of this problem formulation is the need to incorporate future information into the predictions directly. For example, when forecasting electric demand for a particular region over the next month, the calendar variables (date, month, day of week, etc.) and weather forecasts are known.

Formally, the MMMF method directly models the following relationships:

ŷₜ, . . . ,ŷₜ₊ₖ=ƒ(xₜ₋₁, . . . ,x_{t-T},yₜ₋₁, . . . ,y_{t-T},xₜ, . . . ,xₜ₊ₖ) EQ. 1

where ƒ is the function being modeled, ŷₜ are estimations of the ground truth y t values, xₜ₋₁, . . . , x_{t-T} are the past predictor variables, yₜ₋₁, . . . , y_{t-T} are the past forecast variables, and xₜ, xₜ₊ₖ are the future predictor variables.

Traditionally, there are three most common machine learning formulations for modeling such a multi-step multivariate forecasting problem.

First is the sample-based forecasting (SBF) approach shown in graph 100. This formulation treats each step as a distinct sample, and learns a function that maps the predictor variables to forecast variables directly without considering the temporal de-pendency, i.e., they model the following relationship:

ŷₜ=ƒ(xₜ), . . . ,ŷₜ₊ₖ=f(xₜ₊ₖ) EQ. 2

This non-time series direct mapping from input to output could use any traditional regression models, e.g., Linear Regression, fully connected neural networks, etc. How-ever, it falls apart if there are no predictor variables but only forecast variables. Another disadvantage of this approach is that the temporal information is lost and recent history would not affect the forecasts.

Second, is the recursive single-step forecasting (RSF) approach shown in graph 105. This formulation is the standard next step prediction (NSP) task for a time series, where during training a one-step forward prediction model is learned, i.e., the loss is only calculated on the next step. That learned model is then being applied recursively during inference, i.e.:

ŷₜ=ƒ(xₜ₋₁, . . . ,x_{t-T},yₜ₋₁, . . . ,y_{t-T})

ŷₜ₊ₖ=ƒ(xₜ₋₁, . . . ,x_{t-T+}1,ŷₜ,yₜ₋₁, . . . ,y_{t-T+1}) EQ. 3

RSF does use all future information during training because the task is simply NSP. The major disadvantage of this formulation is that it makes predictions based on previous predictions, thus compounding errors will grow with the increasing number of steps.

Third is the direct multi-step forecasting (DMF) approach shown in graph 110. This formulation directly generates multiple outputs for all future steps of forecast variables in a time series, given past information, i.e.:

ŷₜ, . . . ,ŷₜ₊ₖ=ƒ(xₜ₋₁, . . . ,x_{t-T},yₜ₋₁, . . . ,y_{t-T}) EQ. 4

DMF does not utilize the known future information and they simply map the past information to future predictions. Many base models for RSF, such as recurrent neural networks, could be reused for DMF. The difference is how the outputs of those models are mapped, i.e., to 1-step future versus multi-step future forecast variables.

These traditional techniques mainly suffer from two categories of issues. On one hand, SBF does not consider the temporal components and thus could perform poorly when the forecasting horizon is short. On the other hand, RSF and DMF do not utilize the knowledge of some future information for making forecasts. MMMF is proposed to take advantage of both information from the past and the future to make better forecasts.

It should be noted that the goal of this formulation is not to evaluate how good the future predictor variables are, but instead to develop a framework that could assimilate them regardless of how they are generated and use them to predict forecast variables. In real-world scenarios, some predictor variables are clearly defined and deterministic, like day of week, while others come with some uncertainty, like weather forecasts for the next month. The gap in existing formulations that MMMF addresses is that they cannot properly incorporate the known future information. Therefore, MMMF is a more general time series modeling framework than traditional regression models, and if there is no known future information, MMMF reduces to an autoregressive-like masked DMF model.

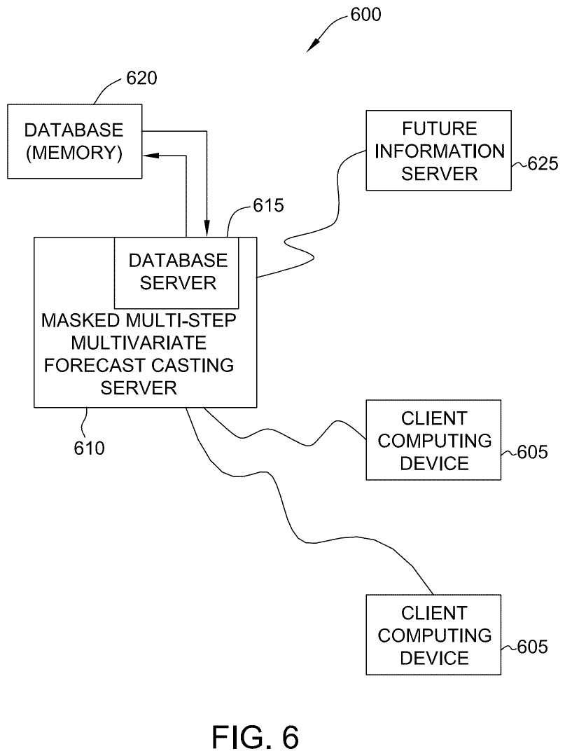

To solve this multi-step multivariate forecasting problem, the MMMF system 600 (as shown in FIG. 6) uses process 200 for MMMF training as described below.

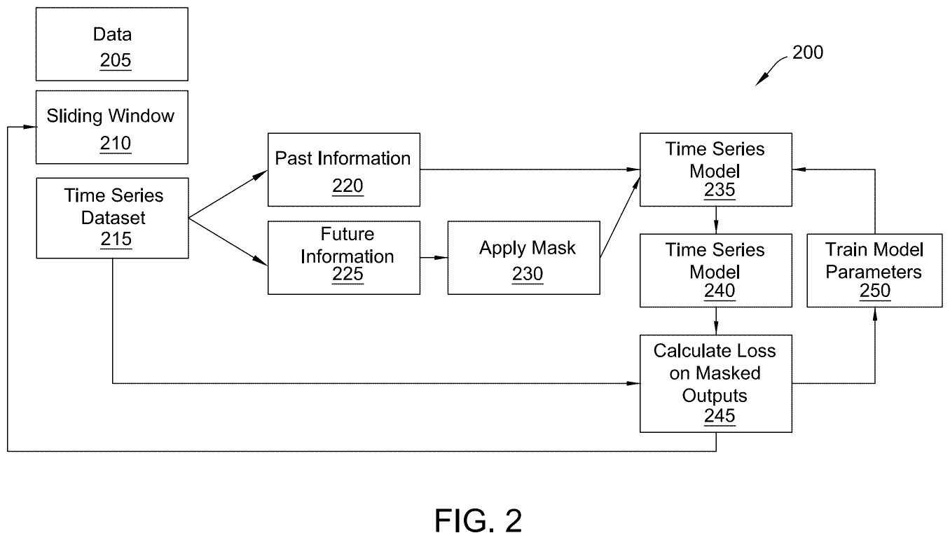

FIG. 2 illustrates block diagram of a process 200 for training a model for masked multi-step multivariate forecasting in accordance with at least one embodiment. In the exemplary embodiment, process 200 is performed by the Masked Multi-Step Multivariate Forecasting (MMMF) server 610 (shown in FIG. 6).

The MMMF server 610 receives a plurality of time-series data 205. In the exemplary embodiment, the time-series data is continuous over a significant period of time. Examples of the time-series data 205 include, but are not limited to, daily weather readings, fuel prices, stock values, economic indicators, and/or other daily information covering a significant period of time, such as one to two years. The plurality of time-series data 205 includes both predictor variables x and forecast variables y for

In other embodiments, the time-series data 205 may include, but is not limited to, sensor reading being made on a periodic basis, including, but not limited to, once a day, once an hour, once a minute, once a second, and/or any other periodic basis.

The MMMF server 610 selects a sliding window 210 of the data 205 to analyze. In the exemplary embodiment, the MMMF server 610 selects a window 210 of 90 continuous readings from the data 205. The data 205 from that window 210 is considered the active time series dataset 215. In some further embodiments, the MMMF server 610 acts in batches and selects a plurality of sliding windows 210 to determine a plurality of time series datasets 215.

The MMMF server 610 takes the dataset(s) 215 and divides them into past information 220 and future information 225. The division into past information 220 and future information 225 is randomized in that the MMMF servers 610 determines a length of the future information 225 between one and 60 readings, while the past information 220 is the remaining information. For example, the MMMF server 610 may determine a length of 30 readings for the future information 225, which will be the last 30 readings and the past information 220 could be the 60 readings before the future information. In at least one embodiment, the size of the future information 225 is limited to two-third of the total time series dataset 215. In the embodiments, where the MMMF server 610 is dealing with multiple datasets 215 at once, each dataset 215 may have the same size for future information 225. In other embodiments, each dataset 215 may have different sizes for the future information 225. In the exemplary embodiment, for each pass of process 200, the size of the future information 225 changes between passes.

The MMMF server 610 applies a mask 230 to the future information 225. The mask 230 is applied to the forecast variables y for all of the data points in the future information 225. In some embodiments, masking techniques may include, but are not limited to, (i) replace with random numbers, (ii) replace with all zeros, (iii) replace with all ones, and/or any other values as appropriate.

The MMMF server 610 applies the past information 220, which includes predictor variables x and forecast variables y, and masked future information 220, which includes predictor variables x and the forecast variables y have been masked, into a time series model 235 that is being trained to determine the forecast variable y. The MMMF server 230 has the time series model 235 generate predictions 240 based on the past information 220 and the masked future information 225.

The MMMF server 610 compares the predictions 240 for the forecast variables y and the forecast variables y for the same data points in the actual time series dataset 215 to calculate losses 245. Based on the differences, the MMMF server 610 trains the model parameters 250. In the exemplary embodiment, the MMMF server 610 adjusts the weights of one or more of the model parameters 250 based on the differences.

The MMMF server 610 then restarts process 200 by selecting a new sliding window 210 for the data 205 to execute on the updated time series model 235. In some embodiments, the MMMF server 610 continues training the time series model 235 with time series datasets 215 from windows 210 of data 205 until one or more ending conditions occur. One example ending condition is that the calculated losses 245 are below a threshold. In some embodiments, the MMMF server 610 ends the training and process 200 when the calculated losses 245 stay below the threshold for a predetermined number of passes of process 200. In other embodiments, the MMMF server 610 ends the training and process 200 when the calculated losses 245 do not change for a predetermined number of passes of process 200. In still further embodiments, the MMMF server 610 ends the training and process 200 when the calculated losses 245 do not change by more than a predetermined threshold amount for a predetermined number of passes of process 200.

Another view of process 200 is a solution for a multivariate time series forecasting problem. Let xₜ∈ [symbol] ⁿ be a sample of predictor variables x with dimension n at time t and the j-th dimension is denoted as xₜ^{j} (i.e., xₜ=[xₜ¹, xₜ², . . . , xₜⁿ]). Let yₜ∈ [symbol] ⁿ be a sample of forecast variables y with dimension m at time t (i.e., yₜ=[yₜ¹, yₜ², . . . , yₜⁿ]). The task of process 200 is to predict up to (k+1) steps (k>0) of forecast variables yₜ, yₜ₊ᵢ, . . . , yₜ₊ₖ from past T-step information and some knowledge about the future predictor variables x up to time t+k.

A distinct feature of this problem formulation is the need to incorporate future information into the predictions directly. For example, when forecasting electric demand for a particular region over the next month, the calendar variables (date, month, day of week, etc.) and weather forecasts are known.

Formally, the MMMF method directly models the following relationships:

ŷₜ, . . . ,ŷₜ₊ₖ=ƒ(xₜ₋₁, . . . ,x_{t-T},yₜ₋₁, . . . ,y_{t-T},xₜ, . . . ,xₜ₊ₖ) EQ. 1

where ƒ is the function being modeled, ŷₜ are estimations of the ground truth yₜ values, xₜ₋₁, . . . , x_{t-T} are the past predictor variables, yₜ₋₁, . . . , y_{t-T} are the past forecast variables, and xₜ, xₜ₊ₖ are the future predictor variables.

To solve this multi-step multivariate forecasting problem, the MMMF system 600 (as shown in FIG. 6) uses process 200 for MMMF training as described below.

The method for MMMF training is given in Algorithm 1 below. The time series model ƒ_{θ} in this algorithm (or the base model for MMMF shown in process 200) can be any neural network model that generates a sequence of outputs. Therefore, one having skill in the art would understand that MMMF is not limited to one model but is a general learning task for all-time series NN (neural network) models.

Algorithm 1 for MMMF training may be used as shown in process 200. The input includes time series model ƒ_{θ} with a set of trainable parameters 0, maximum forecasting horizon k, maximum history length T, loss function [symbol] . The data includes time series dataset S={zᵢ}={(xᵢ, yᵢ)}, where i represents the i-th time step, xᵢ are the predictor variables, yᵢ are the forecast variables. Step one of Algorithm 1 includes preprocessing dataset with a sliding window of length (T+k+1) to {z_{t-T}, . . . , zₜ₋₁, zₜ, zₜ₊₁, . . . , zₜ₊ₖ} sequences, where zₜ is the sample at current step. The second step of Algorithm 1 includes initializing model parameters θ. While not at the end of training epochs and while not at the end of all mini-batches, the MMMF system 600 randomly choses a batch of sequence and then randomly chooses an integer mask length lₘ in for this current batch where 0<lₘ≤k+1. For each sequence in the mini-batch, the MMMF system 600 masks the last lₘ steps of forecast variables ŷ. The MMMF system feeds the masked sequences to the model ƒ_{θ} to generate estimations ŷ using information of x from both the past and future, and unmasked y. The MMMF system calculates loss only on the masked outputs for future predictions, such that Σᵢ₌ₖ₋ₗ_{ₘ}^{i=k} [symbol] (yᵢ, ŷᵢ). The MMMF system 600 backpropogates and updates model parameters θ based on the calculated losses. The MMMF system 600 then returns to randomly choose a batch of sequences and repeats the subsequent steps. The steps repeats until at the end of the training epochs or when convergence occurs.

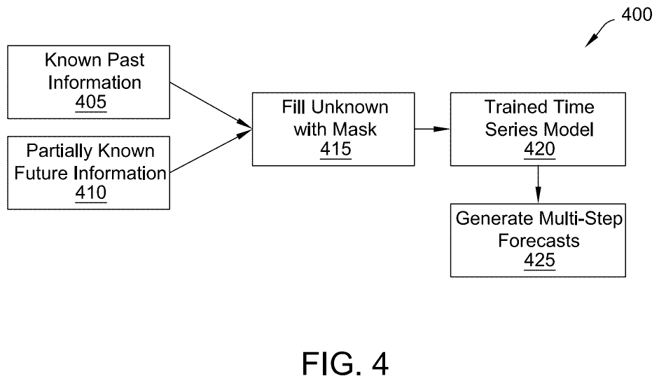

Algorithm 1 outputs a trained model ƒ_{θ}, which may be similar to trained time series model 420 (shown in FIG. 4).

One of the key steps for Algorithm 1 is the random masking of the last lₘ steps of the forecast variables y in the randomly chosen sequence. Because the sequence is chosen randomly for each mini-batch of data, this essentially creates many forecasting sub-tasks where at each iteration the base model ƒ_{θ} is trying to forecast different length outputs. In one extreme, when lₘ=1, the MMMF system 600 reduces to a similar formulation as RSF, with the exception that the information of predictor variables y at time step t is also used. In the other extreme, when lₘ=k+1, the MMMF system 600 reduces to a similar formulation as DMF, with the exception that the information of predictor variables y from time step t to t+k is also used. From this perspective, the learning task of MMMF is more comprehensive than the traditional time series regression tasks, as well as the non-time series SBF regression task.

Different from Masked Language Models (MLMs) such as BERT (Bidirectional Encoder Representations from Transformers) where the tokens are discrete, the time series data is often continuous. Therefore, the MMMF system 600 replaces all masked variables with random values within the ranges of those variables. Different from autoencoders, the MMMF system 600 calculates the loss on only the masked outputs, which is similar to other masked approaches such as BERT, instead of the full reconstruction loss.

Because the MMMF-trained model has learned to generate different lengths of forecasts during its training process, it is very flexible during inference and could generate any length of forecasts from 1 to the maximum forecast horizon k. Fundamentally, the self-supervised learning approach learns a representation of the data by being able to fill in the blanks when some forecast variables are masked. This leads to the flexibility of MMMF-trained models during inference. This includes that they are not restricted to making fixed-length forecasts. This could potentially be useful in some real-world applications, e.g., when an electricity load demand forecast model is trained, it needs to be able to make both short-term forecasts for unit commitment and mid-term forecasts for fuel planning and maintenance planning. Instead of having multiple models for each application, an MMMF-trained model could do all of them.

Furthermore, since masking requires very little additional computational time, MMMF-trained models could generate forecasts at a similar speed as RSF and DMF approaches if they are using the same base model. Given the more complicated learning task, the training time is generally longer for MMMF, but in practice, the inference time is more important for real-world applications. That is to say, MMMF could generate better forecasts at the same speed and memory usage as RSF and DMF models, at the expense of a more difficult training task and longer training time.

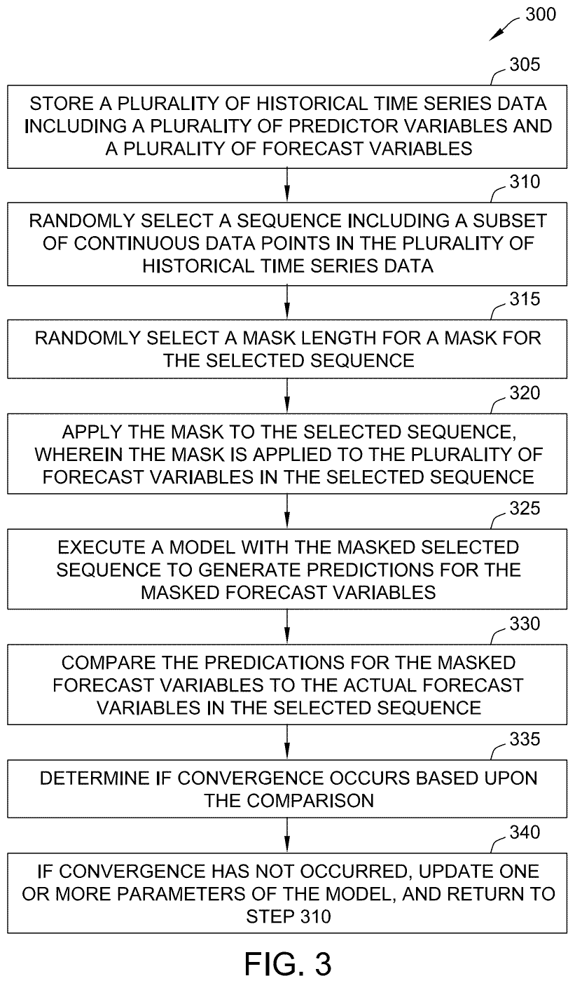

FIG. 3 illustrates a computer-implemented process 300 for training a model for masked multi-step multivariate forecasting using the process 200 (shown in FIG. 2). In the exemplary embodiment, process 300 is performed by the Masked Multi-Step Multivariate Forecasting (MMMF) server 610 (shown in FIG. 6).

In the exemplary embodiment, the MMMF server 610 stores 305 a plurality of historical time series data 205 (shown in FIG. 2) including a plurality of predictor variables and a plurality of forecast variables.

The MMMF server 610 randomly selects 310 a sequence including a subset of continuous data points in the plurality of historical time series data 205. In some embodiments, the sequence is similar to the time series dataset 215 (shown in FIG. 2). The MMMF server 610 randomly selects the sequence including a subset of continuous data points in the plurality of historical time series data. The each randomly selected sequence is different, such that a first selected sequence in a first pass is different than a second selected sequence in a second pass. In the exemplary embodiment, the plurality of historical time series data 205 is significantly larger than the selected sequence or time series dataset 215. For example, the selected sequence may include 90 days worth of data points, while the plurality of historical time series data 205 includes one or more years of data points.

The MMMF server 610 randomly selects 315 a mask length for a mask 230 (shown in FIG. 2) for the selected sequence. The mask length determines how many data points in the selected sequence will be masked out. The MMMF server 610 applies 320 the mask 230 to the selected sequence. The mask 230 is applied to the end of the selected sequence. The masked selected sequence includes unmasked forecast variables followed by masked forecast variables.

The mask 230 is applied 320 to the end of the plurality of forecast variables in the selected sequence. For example, if the sequence has 60 data points and the mask length is 30, then the forecast variables y associated with the last 30 data points in the sequence will be masked. The forecast variables associated with the first 30 data points and all of the predictor variables x are not masked.

The MMMF server 610 executes 325 a model 235 (shown in FIG. 2) with the masked selected sequence to generate predictions 240 (shown in FIG. 2) for the masked forecast variables. The model 235 takes the predictor variables and the unmasked forecast variables and generates values for the masked predictor values.

The MMMF server 610 compares 330 the predictions for the masked forecast variables to the actual forecast variables in the selected sequence. In some embodiments, the MMMF server 610 determines a difference between the masked forecast variable and the forecast variable prior to masking for each masked forecast variable. In at least one embodiment, the MMMF server 610 calculates a loss function 245 (shown in FIG. 2) based on the plurality of differences. In some embodiments, the loss function 245 includes at least one of, but is not limited to, means square error (MSE), means absolute percentage error (MAPE), means absolute percentage deviation (MAPD), mean absolute scale error (MASE), symmetric mean absolute percentage error (sMAPE), Mean Directional Accuracy (MDA), and/or any other error or loss function needed.

The MMMF server 610 determines 335 if convergence occurs based upon the comparison, In some additional embodiments, the MMMF server 610 determines that convergence has occurred if the loss function 245 is below a threshold. The MMMF server 610 can also determine that convergence has occurred if a value of the loss function has not changed in a predetermined number of passes. The MMMF server 610 can further determine that convergence has occurred if an amount of change of the loss function 245 has not exceeded a threshold or if an amount of change of the loss function 245 has not exceeded a threshold for a predetermined number of passes. In still additional embodiments, the MMMF server 610 determines that convergence has occurred after a predetermined plurality of passes through the algorithm.

If convergence has not occurred, the MMMF server 610 updates 640 one or more parameters 250 (shown in FIG. 2) of the model 235 and returns to Step 310 for another pass through process 300.

In some embodiments, the predictor variables include at least one of date, time, weather conditions. In some further embodiments, the forecast variables include electricity demand.

In the exemplary embodiment, when convergence has occurred and the model 235 has been trained. The model 235 may be used for inference predictions, where the model 235 predicts future values. The MMMF server 610 determine a future period of time to predict. This future period of time may be a number of days, hours, minutes, weeks, or any other period of time. The limitation on the period of time is that its maximum is the maximum amount of time in the future that the MMMF system 600 has predictor variable data for.

The MMMF server 610 selects a plurality of historical data points that precede the future period of time to predict. For example, if the future period of time is 30 days, the historical data points may go back 60 days. The plurality of historical data points includes predictor variables and forecast variables for those 60 days. The MMMF server 610 determines predictor variables for the future period of time to predict. In at least one example, the predictor variables include weather information. The MMMF server 610 executes the model 235 with the plurality of historical data points and the predictor variables for the future period of time to generate forecast variables for the future period of time. In some embodiments, the MMMF server 610 masks the forecast variables for the future period of time.

While processes 200 and 300 are described in regards to energy grid predictions based on weather, one having skill in the art would understand that the systems and methods described herein can also be applied to other types of prediction.

FIG. 4 illustrates block diagram of a process for prediction using a masked multi-step multivariate forecasting model in accordance with at least one embodiment. In the exemplary embodiment, process 400 is performed by the Masked Multi-Step Multivariate Forecasting (MMMF) server 610 (shown in FIG. 6).

Another major advantage of the MMMF learning task, which uses all the rest information to forecast the variable-length masked variables, is that once trained a base neural network model can generate forecasts for any forecast length l_{f} for 0<l_{ƒ}<k+1, by simply masking the last l_{ƒ} steps of the desired forecast variables.

In process 400, the MMMF server 610 combines known past information 405 with partially known future information 410. The known past information 405 includes predictor variables x and forecast variables y for a period of time before the present time t. The partially known future information 410 includes predictor variables x for a period of time after the present time t. For example, the past known information 405 could include weather and date information for the predictor variables x and electrical grid usage for the forecast variables y for a period of time, such as 60 days, prior to the present day t. The partially known future information 410 includes weather forecasts and date information for the predictor variables x for a second period of time, such as 30 days, subsequent to the present day t, where the predictor variables y are unknown. The MMMF server 610 fills 415 the unknown predictor variables y in the partially known future information 410 with a mask, which may be similar to the mask 230 (shown in FIG. 2). The mask may include all ones, all zeros, random values, and/or any other values as appropriate.

The MMMF server 610 provides the known past information 405 and the masked partially known information 410 are provided to the trained time series model 420. The trained time series model 420 uses the known past information 405 and the masked partially known information 410 as inputs to execute. The trained time series model 420 executes and generates multi-step forecasts 425 as outputs. The multi-step forecasts 425 include the predictor variables y for the second period of time subsequent to the present time t. In the example case, the predictor variables y include the predicted values for the electrical grid usage for the 30 days after the present time t.

In the exemplary embodiment, the trained time series model 420 may be used for generating multi-step forecasts for time periods where some information is known, where the trained time series model 420 is trained to fill in the unknown information based on the past information and the partially known information.

The method for MMMF inference is given in Algorithm 2 below. The trained time series model ƒ_{θ} in this algorithm (or the base model for MMMF shown in process 400) can be any neural network model that generates a sequence of outputs. Therefore, one having skill in the art would understand that MMMF is not limited to one model but is a general learning task for all-time series NN (neural network) models.

Algorithm 2 for MMMF inference may be used as shown in process 400. The input includes MMMF-trained time series model ƒ_{θ}, forecast horizon l_{ƒ} where 0<l_{ƒ}<k+1. The trained time series model ƒ_{θ} is similar to trained time series model 420. The data includes a sequence of length (T+k+1), with all predictor variables x known, and the last l_{ƒ}-step forecast variables y unknown. In the first step of Algorithm 2, the MMMF system 600 fills the last l_{ƒ}-step forecast variables y with a mask, such as mask 230. Then the MMMF system 600 provides the masked sequence to the trained time series model ƒ_{θ}. The MMMF system 600 executes the trained time series model ƒ_{θ} to generate forecasts ŷ for the last l_{ƒ} steps.

The MMMF system 600 and the trained time series trained time series model ƒ_{θ} output a multi-step multivariate forecast for forecast variables y of length l_{ƒ}, which is similar to multi-step forecasts 425.

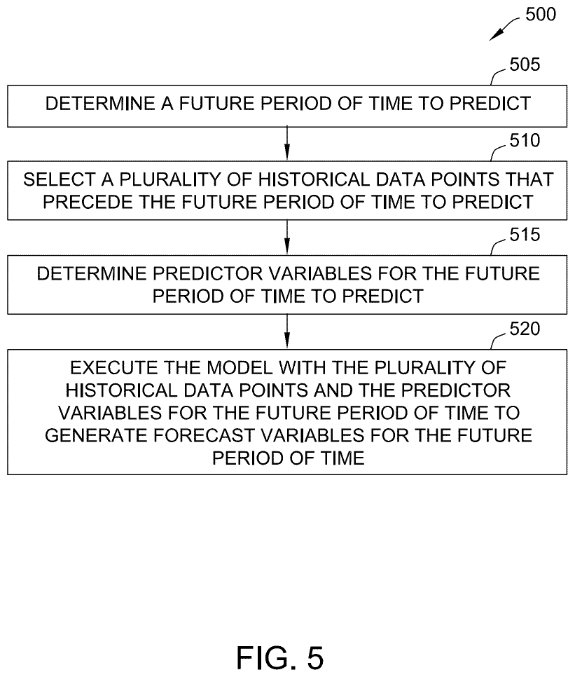

FIG. 5 illustrates a process for training a model for masked multi-step multivariate forecasting using the process shown in FIG. 4. In the exemplary embodiment, process 500 is performed by the Masked Multi-Step Multivariate Forecasting (MMMF) server 610 (shown in FIG. 6).

In the exemplary embodiment, the MMMF server 610 determines 505 a future period of time to predict. In some embodiments, the future period of time to predict is based on a quantity of predictor variables x available for the future period of time. For example, where the predictor variables x are weather forecasts, and the quality of weather forecasting may decrease the further away in time that it is. Therefore, the future period of time may be limited, such as to 30 days and/or any other period of time that the user desires.

In the exemplary embodiment, the MMMF server 610 selects 510 a plurality of historical data points that precede the further period of time to predict. In some embodiments, the plurality of historical data points are from a period of time before the current time that is greater than the future period of time. In one example, if the future period of time is 30 days, the plurality of historical data points covers 60 days prior to the current time. In at least one embodiment, the plurality of historical data points are similar to the known past information 405 (shown in FIG. 4).

In the exemplary embodiment, the MMMF server 610 determines 515 predictor variables x for the future period of time. The predictor variables x may be weather forecasts as described herein. The predictor variables x are filled in for each of the days or data points to be analyzed. In at least one embodiment, the predictor variables x for the future period of time are similar to the partially known future information 410 (shown in FIG. 4).

In the exemplary embodiment, the MMMF server 610 executes 520 the trained time series model 420 with the plurality of historical data points and the predictor variables x for the future period of time to generate forecast variables y for the future period of time.

In some embodiments, the MMMF server 610 masks 320 the forecast variables y for the future period of time.

While processes 400 and 500 are described in regards to energy grid predictions based on weather, one having skill in the art would understand that the systems and methods described herein can also be applied to other types of prediction.

FIG. 6 depicts a simplified block diagram of an exemplary computer system 600 for implementing processes 200, 300, 400, and 500 shown in FIGS. 2, 3, 4, and 5. In the exemplary embodiment, system 600 may be used for predicting future performance of systems, such as power generation systems. As described below in more detail, a masked multi-step multivariate forecasting (MMMF) computer device 610 (also known as MMMF server 610) may be configured to (a) store a plurality of historical time series data 205 (shown in FIG. 2) including a plurality of predictor variables and a plurality of forecast variables; (b) randomly select a sequence including a subset of continuous data points in the plurality of historical time series data 205; (c) randomly select a mask length for a mask 230 (shown in FIG. 2) for the selected sequence; (d) apply the mask 230 to the selected sequence, wherein the mask 230 is applied to the plurality of forecast variables in the selected sequence; (e) execute a model 235 (shown in FIG. 2) with the masked selected sequence to generate predictions 240 (shown in FIG. 2) for the masked forecast variables; (f) compare the predictions 240 for the masked forecast variables to the actual forecast variables in the selected sequence; (g) determine if convergence occurs based upon the comparison; and (h) if convergence has not occurred, update one or more parameters 250 (shown in FIG. 2) of the model 235 and return to step b.

In the exemplary embodiment, client computer devices 605 are computers that include a web browser or a software application, which enables client computer devices 605 to access MMMF server 610 using the Internet. More specifically, client computer devices 605 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client computer devices 605 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, or other web-based connectable equipment or mobile devices.

A database server 615 may be communicatively coupled to a database 620 that stores data. In one embodiment, database 620 may include historical data, further information, models, model parameters, and other information. In the exemplary embodiment, database 620 may be stored remotely from MMMF server 610. In some embodiments, database 620 may be decentralized. In the exemplary embodiment, a person may access database 620 via client computer devices 605 by logging onto MMMF server 610, as described herein.

MMMF server 610 may be communicatively coupled with one or more the client computer devices 605. In some embodiments, MMMF server 610 may be associated with, or is part of a computer network associated with grid operation, or in communication with the grid operation's computer network (not shown). In other embodiments, MMMF server 610 may be associated with a third party and is merely in communication with the grid operation's computer network.

One or more future information servers 625 may be communicatively coupled with MMMF server 610 via the Internet or a local network. More specifically, future information servers 625 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Future information servers 625 may be any device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), chat bots, or other web-based connectable equipment or mobile devices. In the exemplary embodiments, future information servers 625 provide information about future values for x, such as, but not limited to, weather information, gas prices, economic indicators, stock values, population information, demand information, and/or any other information used for modeling future performance.

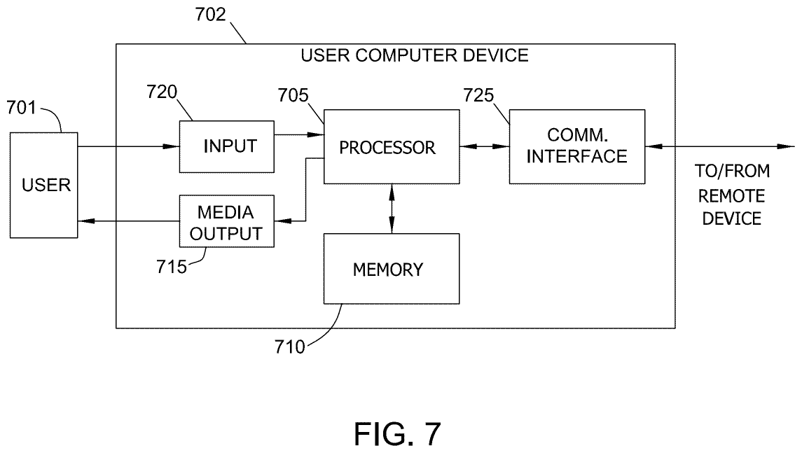

FIG. 7 depicts an exemplary configuration of client computer devices, in accordance with one embodiment of the present disclosure. User computer device 702 may be operated by a user 701. User computer device 702 may include, but is not limited to, client computer device 605 and MMMF computer device 610 (shown in FIG. 6).

User computer device 702 may include a processor 705 for executing instructions. In some embodiments, executable instructions are stored in a memory area 710. Processor 705 may include one or more processing units (e.g., in a multi-core configuration). Memory area 710 may be any device allowing information such as executable instructions and/or transaction data to be stored and retrieved. Memory area 710 may include one or more computer readable media.

User computer device 702 may also include at least one media output component 715 for presenting information to user 701. Media output component 715 may be any component capable of conveying information to user 701. In some embodiments, media output component 715 may include an output adapter (not shown) such as a video adapter and/or an audio adapter. An output adapter may be operatively coupled to processor 705 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 715 may be configured to present a graphical user interface (e.g., a web browser and/or a client application) to user 701. A graphical user interface may include, for example, results of forecasting. In some embodiments, user computer device 702 may include an input device 720 for receiving input from user 701. User 701 may use input device 720 to, without limitation, select a forecast variable to analyze and/or select a time frame to analyze.

Input device 720 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 715 and input device 720.

User computer device 702 may also include a communication interface 725, communicatively coupled to a remote device such as MMMF server 610 (shown in FIG. 6). Communication interface 725 may include, for example, a wired or wireless network adapter and/or a wireless data transceiver for use with a mobile telecommunications network.

Stored in memory area 710 are, for example, computer readable instructions for providing a user interface to user 701 via media output component 715 and, optionally, receiving and processing input from input device 720. A user interface may include, among other possibilities, a web browser and/or a client application. Web browsers enable users, such as user 701, to display and interact with media and other information typically embedded on a web page or a website from MMMF server 610. A client application allows user 701 to interact with, for example, time frames and forecasting results. For example, instructions may be stored by a cloud service, and the output of the execution of the instructions sent to the media output component 715.

Processor 705 executes computer-executable instructions for implementing aspects of the disclosure. In some embodiments, the processor 705 is transformed into a special purpose microprocessor by executing computer-executable instructions or by otherwise being programmed. For example, the processor 705 may be programmed with the instructions such as processes 200, 300, 400, and 500 (shown in FIGS. 2, 3, 4, and 5, respectively).

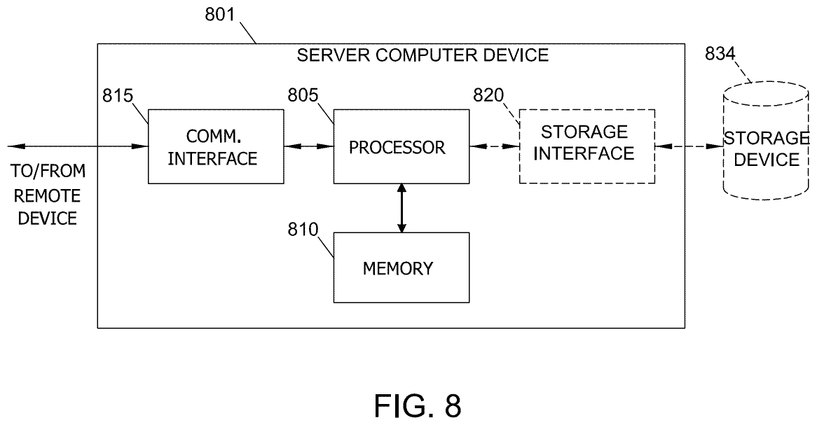

FIG. 8 illustrates an example configuration of the server system, in accordance with one embodiment of the present disclosure. Server computer device 801 may include, but is not limited to, MMMF server 610, database server 615, and future information server 625 (all shown in FIG. 6). Server computer device 801 also includes a processor 805 for executing instructions. Instructions may be stored in a memory area 810. Processor 805 may include one or more processing units (e.g., in a multi-core configuration).

Processor 805 is operatively coupled to a communication interface 815 such that server computer device 801 is capable of communicating with a remote device such as another server computer device 801, MMMF server 610, client computer device 605 (shown in FIG. 6), or future information server 625. For example, communication interface 815 may receive requests from client computer devices 605 via the Internet.

Processor 805 may also be operatively coupled to a storage device 834. Storage device 834 is any computer-operated hardware suitable for storing and/or retrieving data, such as, but not limited to, data associated with database 620 (shown in FIG. 6). In some embodiments, storage device 834 is integrated in server computer device 801. For example, server computer device 801 may include one or more hard disk drives as storage device 834. In other embodiments, storage device 834 is external to server computer device 801 and may be accessed by a plurality of server computer devices 801. For example, storage device 834 may include a storage area network (SAN), a network attached storage (NAS) system, and/or multiple storage units such as hard disks and/or solid state disks in a redundant array of inexpensive disks (RAID) configuration.

In some embodiments, processor 805 is operatively coupled to storage device 834 via a storage interface 820. Storage interface 820 is any component capable of providing processor 805 with access to storage device 834. Storage interface 820 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 805 with access to storage device 834.

Processor 805 executes computer-executable instructions for implementing aspects of the disclosure. In some embodiments, the processor 805 is transformed into a special purpose microprocessor by executing computer-executable instructions or by otherwise being programmed. For example, the processor 805 is programmed with the instructions such as processes 200, 300, 400, and 500 (shown in FIGS. 2, 3, 4, and 5, respectively).

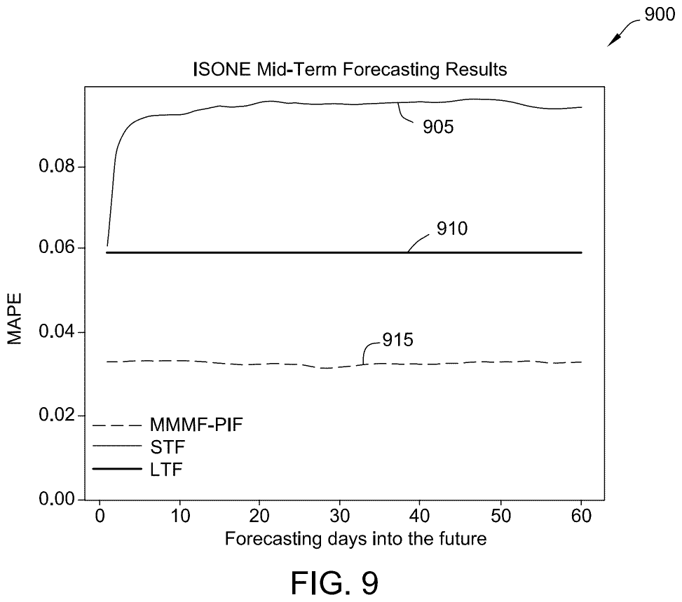

FIG. 9 illustrates a graph 900 of comparing different forecasting techniques in accordance with at least one embodiment. Graph 900 illustrates mid-Term Forecasting Results. Graph 900 illustrates the means absolute percentage error (MAPE) for different forecasting styles based on the number of days into the future that are being forecast. Line 905 illustrates the MAPE for short-term forecasting (STF). Line 910 illustrates the MAPE for long-term forecasting (LTF). And line 915 illustrates the MAPe for the MMMF system 600 described herein.

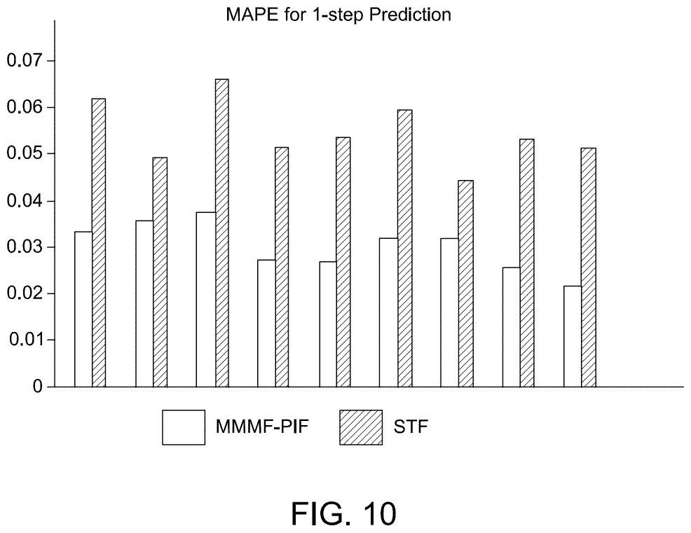

FIG. 10 illustrates another graph 1000 of comparing different forecasting techniques in accordance with at least one embodiment. Graph 1000 illustrates the means absolute percentage error (MAPE) for a single step prediction. Graph 100 shows significantly more error for short-term forecasting (STF) than for the MMMF system 600 described herein.

In at least one embodiment, the MMMF system 600 is provided. The MMMF system 600 includes a MMMF computing device 610 including at least one processor 805 in communication with at least one memory device 810. The at least one processor 805 is programmed to perform a plurality of steps. The MMMF computing device 610 is programmed to store 305 a plurality of historical time series data 205 including a plurality of predictor variables and a plurality of forecast variables. The MMMF computing device 610 is also programmed to randomly select 310 a sequence including a subset 215 of continuous data points in the plurality of historical time series data 205. The MMMF computing device 610 is further programmed to randomly select 315 a mask length for a mask 230 for the selected sequence 215. In addition, the MMMF computing device 610 is programmed to apply 320 the mask 230 to the selected sequence 215. The mask 230 is applied 320 to the plurality of forecast variables in the selected sequence 215. Furthermore, the MMMF computing device 610 is programmed to execute 325 a model 235 with the masked selected sequence 215 to generate predictions 240 for the masked forecast variables. Moreover, the MMMF computing device 610 is programmed to compare 330 the predictions 240 for the masked forecast variables to the actual forecast variables in the selected sequence 215. In addition, the MMMF computing device 610 also is programmed to determine 335 if convergence occurs based upon the comparison. If convergence has not occurred, the MMMF computing device 610 is programmed to update 340 one or more parameters 250 of the model 235 and return to step 310.

In an embodiment, the MMMF computing device 610 compares the predictions 240 for the masked forecast variables to the actual forecast variables in the selected sequence by determining a difference between the masked forecast variable and the forecast variable prior to masking for each masked forecast variable.

In another embodiment, the MMMF computing device 610 is further programmed to calculate a loss function 245 based on the plurality of differences. The loss function includes at least one of means square error (MSE) and means absolute percentage error (MAPE). The MMMF computing device 610 is programmed to determine that convergence has occurred if the loss function 245 is below a threshold. The MMMF computing device 610 is further programmed to determine that convergence has occurred if a value of the loss function 245 has not changed in a predetermined number of passes. In addition, the MMMF computing device 610 is programmed to determine that convergence has occurred if an amount of change of the loss function 245 has not exceeded a threshold. Furthermore, the MMMF computing device 610 is programmed to determine that convergence has occurred if an amount of change of the loss function 245 has not exceeded a threshold for a predetermined number of passes. Moreover, the MMMF computing device 610 is programmed to determine that convergence has occurred after a predetermined plurality of passes through the algorithm.

The MMMF computing device 610 is further programmed to randomly select the sequence 215 including a subset of continuous data points in the plurality of historical time series data 205. A first selected sequence in a first pass is different than a second selected sequence in a second pass. The plurality of historical time series data 205 is significantly larger than the selected sequence 205.

In further embodiments, the masked selected sequence includes unmasked forecast variables followed by masked forecast variables. In some embodiments, the predictor variables include at least one of date, time, weather conditions. In further embodiments, the forecast variables include electricity demand.

In a further embodiment, the MMMF computing device 610 is programmed to determine 505 a future period of time to predict. The MMMF computing device 610 is programmed to select 510 a plurality of historical data points 405 that precede the future period of time to predict. The plurality of historical data points 405 includes predictor variables and forecast variables. The MMMF computing device 610 determines 515 predictor variables for the future period of time to predict. The MMMF computing device 610 executes 520 the model 420 with the plurality of historical data points 405 and the predictor variables for the future period of time to generate forecast variables 425 for the future period of time. The MMMF computing device 610 is also programmed to mask 415 the forecast variables for the future period of time. The mask 230 is applied to the end of the selected sequence 215.

In another embodiment, a computer-implemented method 300 is implemented by the MMMF computing device 610 including at least one processor 805 in communication with at least one memory device 810. The method 300 includes storing 305 a plurality of historical time series data 205 including a plurality of predictor variables and a plurality of forecast variables. The method 300 also includes randomly selecting 310 a sequence 215 including a subset of continuous data points in the plurality of historical time series data 205. The method 300 further includes randomly selecting 315 a mask length for a mask 230 for the selected sequence. In addition, the method 300 includes applying 320 the mask 230 to the selected sequence 215. The mask 230 is applied to the plurality of forecast variables in the selected sequence 215. Moreover, the method 300 includes executing 325 a model 235 with the masked selected sequence 215 to generate predictions 240 for the masked forecast variables. Furthermore, the method 300 includes comparing 330 the predictions for the masked forecast variables to the actual forecast variables in the selected sequence 215. In addition, the method 300 includes determining 335 if convergence occurs based upon the comparison. If convergence has not occurred, the method 300 includes updating 340 one or more parameters 250 of the model 235 and return to step 310.

In a further embodiment, the method 300 includes determining a difference between the masked forecast variable and the forecast variable prior to masking for each masked forecast variable. The method 300 also includes calculating a loss function 245 based on the plurality of differences. The method 300 further includes determining that convergence has occurred if the loss function 245 is below a threshold, if a value of the loss function 245 has not changed in a predetermined number of passes, if an amount of change of the loss function 245 has not exceeded a threshold, if an amount of change of the loss function 245 has not exceeded a threshold for a predetermined number of passes, or after a predetermined plurality of passes through the algorithm 300.

In still a further embodiment, a method 500 includes determining 505 a future period of time to predict. The method 500 also includes selecting 510 a plurality of historical data points 405 that precede the future period of time to predict. The plurality of historical data points 405 includes predictor variables and forecast variables. The method further includes determining 515 predictor variables for the future period of time to predict. In addition, the method includes executing 520 the model 420 with the plurality of historical data points 405 and the predictor variables for the future period of time to generate forecast variables 425 for the future period of time.

At least one of the technical solutions to the technical problems provided by this system may include: (i) improved accuracy in short and mid-term forecasting; (ii) significantly reduced error in forecasting; (iii) ability to forecast based on historical and future data; (iv) forecasting not limited based on neural network used; and (v) able to be applied to multiple different models for training.

The methods and systems described herein may be implemented using computer programming or engineering techniques including computer software, firmware, hardware, or any combination or subset thereof, wherein the technical effects may be achieved by performing at least one of the following steps: a) store a plurality of historical time series data including a plurality of predictor variables and a plurality of forecast variables, wherein the predictor variables include at least one of date, time, weather conditions, wherein the forecast variables include electricity demand; b) randomly select a sequence including a subset of continuous data points in the plurality of historical time series data; c) randomly select a mask length for a mask for the selected sequence; d) apply the mask to the selected sequence, wherein the mask is applied to the plurality of forecast variables in the selected sequence, wherein the mask is applied to the end of the selected sequence, wherein the masked selected sequence includes unmasked forecast variables followed by masked forecast variables; e) execute a model with the masked selected sequence to generate predictions for the masked forecast variables; f) compare the predictions for the masked forecast variables to the actual forecast variables in the selected sequence; g) determine if convergence occurs based upon the comparison; h) if convergence has not occurred, update one or more parameters of the model and return to step b; i) for each masked forecast variable, determine a difference between the masked forecast variable and the forecast variable prior to masking; j) calculate a loss function based on the plurality of differences, wherein the loss function includes at least one of means square error (MSE) and means absolute percentage error (MAPE); k) determine that convergence has occurred if the loss function is below a threshold; l) determine that convergence has occurred if a value of the loss function has not changed in a predetermined number of passes; m) determine that convergence has occurred if an amount of change of the loss function has not exceeded a threshold; n) determine that convergence has occurred if an amount of change of the loss function has not exceeded a threshold for a predetermined number of passes; o) determine that convergence has occurred after a predetermined plurality of passes through the algorithm; p) determine a future period of time to predict; q) select a plurality of historical data points that precede the future period of time to predict, wherein the plurality of historical data points includes predictor variables and forecast variables; r) determine predictor variables for the future period of time to predict, wherein the at least one processor is further programmed to mask the forecast variables for the future period of time; s) execute the model with the plurality of historical data points and the predictor variables for the future period of time to generate forecast variables for the future period of time; and t) randomly select the sequence including a subset of continuous data points in the plurality of historical time series data, wherein a first selected sequence in a first pass is different than a second selected sequence in a second pass, wherein the plurality of historical time series data is significantly larger than the selected sequence.

The computer-implemented methods and processes described herein may include additional, fewer, or alternate actions, including those discussed elsewhere herein. The present systems and methods may be implemented using one or more local or remote processors, transceivers, and/or sensors (such as processors, transceivers, and/or sensors mounted on computer systems or mobile devices, or associated with or remote servers), and/or through implementation of computer-executable instructions stored on non-transitory computer-readable media or medium. Unless described herein to the contrary, the various steps of the several processes may be performed in a different order, or simultaneously in some instances.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing sensor data, and detecting abnormalities.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising a computing device including at least one processor in communication with at least one memory device, wherein the at least one processor is programmed to perform the steps of:
(a) store a plurality of historical time series data including a plurality of predictor variables and a plurality of forecast variables;
(b) randomly select a sequence including a subset of continuous data points in the plurality of historical time series data;
(c) randomly select a mask length for a mask for the selected sequence;
(d) apply the mask to the selected sequence, wherein the mask is applied to the plurality of forecast variables in the selected sequence;
(e) execute a model with the masked selected sequence to generate predictions for the masked forecast variables;
(f) compare the predictions for the masked forecast variables to the actual forecast variables in the selected sequence;
(g) determine if convergence occurs based upon the comparison; and
(h) if convergence has not occurred, update one or more parameters of the model and return to step b.

2. The system of claim 1, wherein to compare the predictions for the masked forecast variables to the actual forecast variables in the selected sequence the at least one processor is further programmed to perform the steps of:
for each masked forecast variable, determine a difference between the masked forecast variable and the forecast variable prior to masking.

3. The system of claim 2, wherein the at least one processor is further programmed to calculate a loss function based on the plurality of differences.

4. The system of claim 3, wherein the loss function includes at least one of means square error (MSE) and means absolute percentage error (MAPE).

5. The system of claim 3, wherein the at least one processor is further programmed to determine that convergence has occurred if the loss function is below a threshold.

6. The system of claim 3, wherein the at least one processor is further programmed to determine that convergence has occurred if a value of the loss function has not changed in a predetermined number of passes.

7. The system of claim 3, wherein the at least one processor is further programmed to determine that convergence has occurred if an amount of change of the loss function has not exceeded a threshold.

8. The system of claim 3, wherein the at least one processor is further programmed to determine that convergence has occurred if an amount of change of the loss function has not exceeded a threshold for a predetermined number of passes.

9. The system of claim 1, wherein the at least one processor is further programmed to determine that convergence has occurred after a predetermined plurality of passes through the algorithm.

10. The system of claim 1, wherein the at least one processor is further programmed to:
determine a future period of time to predict;
select a plurality of historical data points that precede the future period of time to predict, wherein the plurality of historical data points includes predictor variables and forecast variables;
determine predictor variables for the future period of time to predict; and
execute the model with the plurality of historical data points and the predictor variables for the future period of time to generate forecast variables for the future period of time.

11. The system of claim 10, wherein the at least one processor is further programmed to mask the forecast variables for the future period of time.

12. The system of claim 1, wherein the at least one processor is further programmed to randomly select the sequence including a subset of continuous data points in the plurality of historical time series data, wherein a first selected sequence in a first pass is different than a second selected sequence in a second pass.

13. The system of claim 1, wherein the plurality of historical time series data is significantly larger than the selected sequence.

14. The system of claim 1, wherein the mask is applied to the end of the selected sequence, wherein the masked selected sequence includes unmasked forecast variables followed by masked forecast variables.

15. The system of claim 1, wherein the predictor variables include at least one of date, time, weather conditions.

16. The system of claim 1, wherein the forecast variables include electricity demand.

17. A computer-implemented method implemented by a computing device including at least one processor in communication with at least one memory device, wherein the method includes performing the steps of:
(a) storing a plurality of historical time series data including a plurality of predictor variables and a plurality of forecast variables;
(b) randomly selecting a sequence including a subset of continuous data points in the plurality of historical time series data;
(c) randomly selecting a mask length for a mask for the selected sequence;
(d) applying the mask to the selected sequence, wherein the mask is applied to the plurality of forecast variables in the selected sequence;
(e) executing a model with the masked selected sequence to generate predictions for the masked forecast variables;
(f) comparing the predictions for the masked forecast variables to the actual forecast variables in the selected sequence;
(g) determining if convergence occurs based upon the comparison; and
(h) if convergence has not occurred, updating one or more parameters of the model and return to step b.

18. The method in accordance with claim 17 further comprising:
for each masked forecast variable, determining a difference between the masked forecast variable and the forecast variable prior to masking; and
calculating a loss function based on the plurality of differences.

19. The method in accordance with claim 18 further comprising determining that convergence has occurred if the loss function is below a threshold, if a value of the loss function has not changed in a predetermined number of passes, if an amount of change of the loss function has not exceeded a threshold, if an amount of change of the loss function has not exceeded a threshold for a predetermined number of passes, or after a predetermined plurality of passes through the algorithm.

20. The method in accordance with claim 17 further comprising:
determining a future period of time to predict;
selecting a plurality of historical data points that precede the future period of time to predict, wherein the plurality of historical data points includes predictor variables and forecast variables;
determining predictor variables for the future period of time to predict; and
executing the model with the plurality of historical data points and the predictor variables for the future period of time to generate forecast variables for the future period of time.
